(19) United States
(12) Patent Application Publication
(10) Pub. No.: US 2017/0344985 A1
(43) Pub. Date: Nov. 30, 2017

(54) SYSTEM AND METHOD FOR ACCOUNT SECURITY

(71) Applicant: Netspend Corporation, Austin, TX (US)

(72) Inventor: Wade Weisser, Austin, TX (US)

(21) Appl. No.: 15/164,492

(22) Filed: May 25, 2016

(51) Int. Cl. G06Q 20/40; G06Q 40/02; G06Q 20/20

(52) U.S. Cl. CPC G06Q 20/40; G06Q 20/20; G06Q 40/02

(57) ABSTRACT

A system for securing accounts and features within such accounts, which may allow user interaction and may provide increased security and usability of accounts to users by providing real-time, flexible, selection of features. Selection of features may be performed remotely. Such features may include the ability to select an overdraft feature in real-time when a need for the overdraft feature is determined to be needed. This may provide the user a degree of control to precisely define the scope of the overdraft feature, thus better securing the use of the user's account.

### TECHNICAL FIELD OF THE INVENTION

The present invention relates generally to integrated network systems and more particularly to a user-activated system and method that provides users with multiple activation feature selection options for securing use of an account.

### BACKGROUND

Database systems provide various services to their users. Users may access accounts on the database systems to perform various administrative tasks associated with possible use of the accounts. Such accounts may include balances or credits with respect to other entities, such as affinity marketing, credit, pre-paid debit, or other accounts. Accounts may be used to transfer, withdraw, or deposit units of value. Many database systems operate using periodic settlement of outstanding transactions. Transactions are accumulated throughout the period (e.g., a day) and then settlement occurs between different parties. The value in a user's account can vary throughout the period. Overdrafts occur, when at settlement time, pending transactions exceed the account. After settlement occurs and an account is overdrawn, the difference between the pending transactions and the value of the account is often temporarily covered by the entity backing the database system. The user is charged an overdraft fee.

### SUMMARY

In one embodiment, a method includes receiving, from a user, an activation feature selection; evaluating a type of the activation feature selection; determining whether the user is eligible to enable at least one overdraft transaction; and based on receiving the activation feature selection and on a determination that the user is eligible to enable an overdraft transaction, activating an overdraft feature based on the type of the activation feature selection. The activation feature selection type may be a specified time period-based, a transaction-based, or a point-of-sale-based.

In another embodiment, a system comprises a processor, a non-transitory computer-readable medium, and instructions on the non-transitory computer-readable medium, the instructions, when read and executed by the processor, configure the processor to: receive, from a user, an activation feature selection; evaluate a type of the activation feature selection; determine whether the user is eligible to enable at least one overdraft transaction; and based on receiving an activation feature selection and on a determination that the user is eligible to enable an overdraft transaction, activate an overdraft feature based on the type of the activation feature selection. The activation feature selection type may be a specified time period-based, a transaction-based, or a point-of-sale-based.

In yet another embodiment, a computer program embodied in computer readable media comprises instructions, the instructions executable by a processor, and the instructions configured to, when loaded and executed, cause the processor to: receive, from a user, an activation feature selection; evaluate a type of the activation feature selection, the type to include one or more of a specified time period-based, a transaction-based, or a point-of-sale-based; determine whether the user is eligible to enable at least one overdraft transaction; and based on receiving an activation feature selection and on a determination that the user is eligible to enable an overdraft transaction, activate an overdraft feature based on the type of the activation feature selection. The activation feature selection type may be a specified time period-based, a transaction-based, or a point-of-sale-based.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an example embodiment of a system for account security;

FIG. 2 illustrates an example embodiment of a server application, showing the interaction of the server application and the application database to produce output;

FIG. 3 illustrates an example embodiment of the server application, showing the interaction of the server application and the application database to produce output;

FIG. 4 illustrates an example embodiment of the server application, showing the interaction of the server application and the application database to produce output;

FIG. 5 illustrates the operation of an embodiment of the server application interacting with a user application and performing the activation feature selection type specified time period-based or transaction-based;

FIG. 6 illustrates the operation of an embodiment of the server application interacting with a user application and performing the activation feature selection type point-of-sale-based;

FIG. 7 shows a method for determining whether an input is a transaction or an activation feature selection, and if an activation feature selection, determining the type of activation feature selection;

FIG. 8 shows a method for authorizing an overdraft transaction based on a determination that the type of activation feature selection selected by the user is specified time period-based;

FIG. 9 shows a method for authorizing an overdraft transaction based on a determination that the type of activation feature selection selected by the user is transaction-based; and

FIG. 10 shows a method for authorizing an overdraft transaction based on a determination that the type of activation feature selection selected by the user is point-of-sale-based.

### DETAILED DESCRIPTION

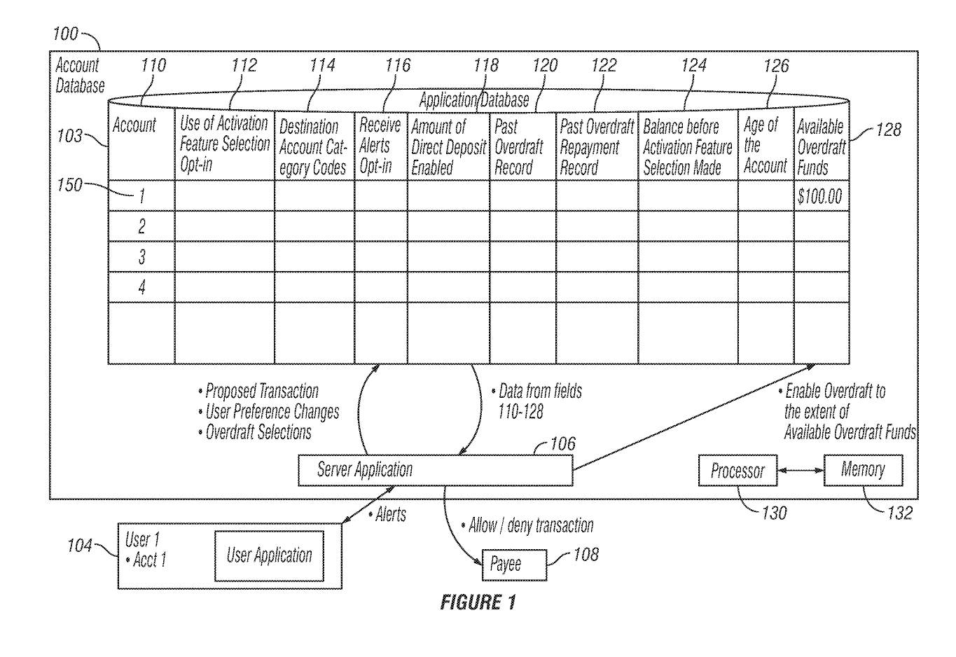

FIG. 1 is an example embodiment of a system 100 for securing accounts and features within such accounts. In various embodiments, system 100 may require user authorization to participate in some features. The features may include those that may cause the user to have a negative balance in its accounts. Such negative balances may incur undesirable side-effects, such as freezing of accounts, additional fees, or unavailability of other features when using system 100. However, these negative balances may be outweighed by a benefit of authorizing a transaction. System 100 may provide increased security and usability of accounts to users by providing real-time, flexible, selection of features. In one embodiment, such features may include the ability to select an overdraft feature. In another embodiment, such features may include the ability to select an overdraft feature limited to a subsequent overdraft feature. System 100 may present the ability to select overdraft features in real-time when a need for the overdraft feature is determined to be needed. System 100 may present the ability to select overdraft features to a user in a manner that gives the user the ability to select the overdraft feature remotely and with a degree of control to precisely define the scope of the overdraft feature, thus better securing the use of the user's account.

System 100 may be configured to solicit users to authorize an overdraft transaction. The transaction may be from a user's account containing account funds insufficient to otherwise complete a transaction. The transaction may be anticipated by the user. Furthermore, the transaction may have just been attempted by the user. The application of overdraft transaction funds to complete the overdraft transaction may be initiated by the user. The user may securely initiate the overdraft transaction by selecting an activation feature selection on the user application 104.

System 100 may be configured to operate on one or more electronic devices, computers, servers, or other appropriate mechanisms. System 100 may include any suitable number and kind of components. Although a single system 100 is shown, portions of system 100 may be duplicated, replicated, or otherwise be embodied or operated in different components. For example, system 100 is shown with a single server application 106 and user account 150, though system 100 may include many such applications and accounts. Server application 106 may be configured to handle input and output to users, payees, other systems, or other entities. Instructions for server application 106 may reside in a memory 132 for execution by a processor 130. When executed, the instructions may configure the server application 106 to perform the functionality described in this disclosure. Although certain operations of server application 106 are shown, the operation of server application 106 may be accomplished by other portions of system 100, and vice-versa.

System 100 may include a user account 150, configured to be accessible by one or more server applications 106. Data comprising user account 150 may be contained within one or more databases. For example purposes, user account 150 and its associated data are contained within database 103. The data associated with user account 150 may include, but is not limited to, data of categories 110-128. User account 150 may be tied to a specific user. In one embodiment, user account 150 may be configured to be associated with an electronic device, such as a smartphone, of a specific user. User account 150 may be configured to be accessible from a user application 104 operating on such electronic device. In certain embodiments, user account 150 may be a prepaid debit account or a general purpose reloadable account.

The data associated with user account 150 may be contained in database 103, which may include data of categories 110-128:

Data field 110 may provide information sufficient to identify account 150 (e.g., account number), and may also provide information indicating whether account 150 is a valid user account (e.g., not suspended or in breach of a system policy).

Data field 112 may provide information of whether the user has opted-in to use of activation feature selections that may be offered to user application 104. In various embodiments, if the user has not opted-in to use of activation feature selections, user application 104 may not display options for activation feature selection types specified time period-based or transaction-based, but may display activation feature selection type point-of-sale-based in the event an overdraft transaction has been attempted and already declined. In such embodiments, if the user has opted-in to use of activation feature selections, user application 104 may display options for activation feature selection types specified time period-based, transaction-based, and/or point-of-sale-based.

Data field 114 may identify whether the attempted or proposed overdraft transaction is acceptable given the value of destination account category code 114, signifying the type of destination account. For example, a destination account may be characterized by a merchant category code. In one example, if the merchant category code of payee 108 corresponds to an authorized merchant category code of data field 114, system 100 may authorize an overdraft transaction with payee 108. However, if the merchant category code of payee 108 does not correspond to an authorized merchant category code of data field 114, system 100 may decline an overdraft transaction with payee 108.

Examples of destination account codes in data field 114 that might be authorized may include grocery stores, convenience stores, hospitals or other medical care, dental care, and gas stations. Examples of destination account codes in data field 114 that might be unauthorized may include bars or cocktail lounges, gambling venues, adult entertainment, securities brokers/dealers, and payment of a debt to another financial institution. Consideration of data field 114 improves the ability of system 100 to secure user accounts because the entity backing the data system must temporarily cover the difference between the pending transactions and the value of the account, when settlement occurs and an account is overdrawn. Entities backing such data systems may prefer not to cover certain transactions with particular categories of destination accounts for many reasons. Such reasons may include risk, liability, public perception, inconsistency with its business model or goals, and difficulty in resolving disputes with entities backing such destination accounts.

Data field 116 may provide information of whether the user account 150 has opted-in to receiving alerts from system 100. Such alerts may be displayed by user application 104.

Data field 118 may provide information of whether the amount of direct deposit enabled to be regularly deposited in user account 150 may exceed a specified threshold. In various embodiments, data field 118 may identify that a sufficient amount of direct deposit is enabled if the amount is greater than zero units; data field 118 may identify that an insufficient amount of direct deposit is enabled if the amount is equal or lesser than zero units.

Data field 120 may provide information of the past overdraft transaction record of user account 150, which may include whether the past overdraft transaction record does not exceed a specified threshold (e.g., not greater than three overdraft transactions have been completed within the prior week or since the last direct deposit was entered).

Data field 122 may provide information of the past overdraft transaction repayment record of user account 150, which may include whether the past overdraft repayment record of is within a specified range. For example, account 150 may be provided a “grace period” window for repayment of an overdraft amount, during which no overdraft fee will be incurred if the account has been restored to a positive or non-negative balance. In various embodiments, the past overdraft repayment record may identify whether the account has been restored to a positive or non-negative balance during the “grace period” following at least half of the overdraft transactions made by the account.

Data field 124 may provide information of the balance of user account 150 before server application 106 receives an activation feature selection from user application 104.

Data field 126 may provide information of whether the age of user account 150 is greater than a specified threshold, which may include the length of time the account has been in existence, the length of time the account has opted-in to use of activation feature selections, or the length of time direct deposit has been enabled to the account. In various embodiments, data field 126 may identify that account 150 is of a sufficient age if, for example, the account has been in existence for greater than a week, the account has opted-in to use of activation feature selections for greater than a month, and/or direct deposit has been enabled for greater than six months or other specified time period.

Data field 128 may provide information of the quantity of overdraft funds available to user account 150 to complete an overdraft transaction. Server application 106 may consider, but is not limited to only consideration of, the data contained in fields 110-128 to generate data field 128, which may be used to determine whether user account 150 has sufficient overdraft funds available to complete an overdraft transaction.

The data of fields 110-128 in application database 103 may be drawn from external sources. For example, application database 103 may access external networks to retrieve the information illustrated in data fields 110-128. Such external networks may include, for example, an intranet, the Internet, local area networks, wide-area-networks, or any suitable combination thereof.

Payee 108 may include any suitable recipient of funds from account 150 as described herein. For example, payee 108 may include other account holders, businesses or merchants, or retail outlets.

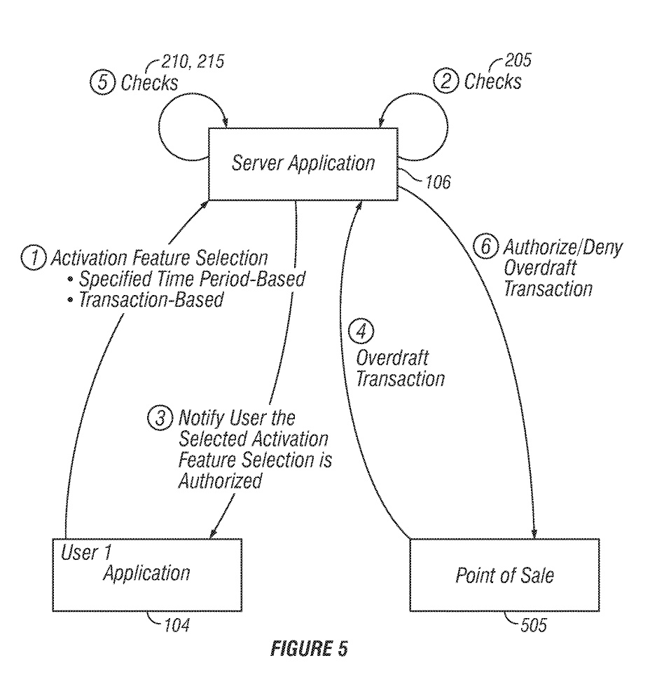

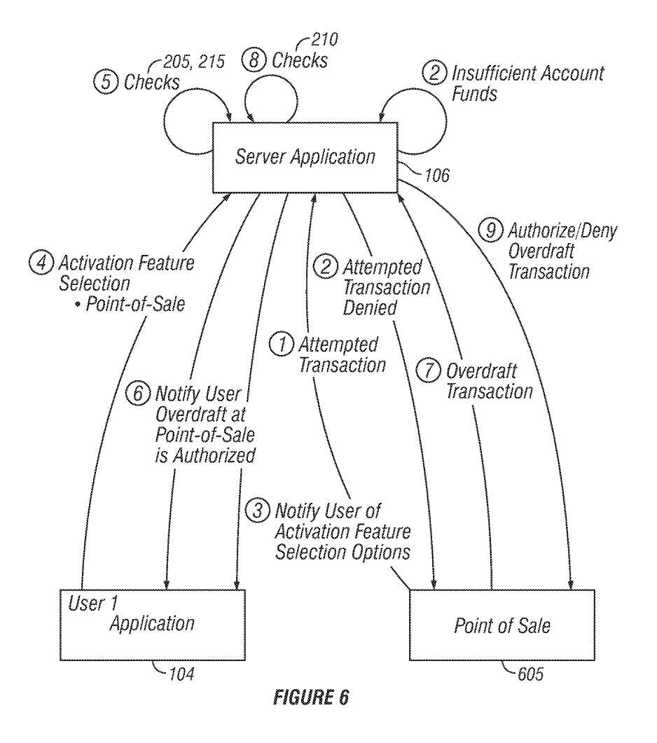

User application 104 may be configured to access user account 150 upon request by a user of system 100, and may be configured to be associated with an electronic device, such as a smartphone, of a specific user. In various embodiments, user application 104 may be secured by a user login prior to allowing access to account 150. Once logged in, user application 104 may be configured to provide the user with activation feature selection options such as transaction-based, specified time period-based, or point-of-sale based (as contemplated in FIGS. 5-6). User application 104 may be configured to display any information related to selection of an activation feature selection or a subsequent overdraft feature after an initial selection is made (e.g., terms and conditions related to an overdraft transaction). User application 104 may also be configured to display information related to performance of an activation feature selection, such as a future time at which the transaction may be completed. By providing such display of activation feature selections, user application 104 may enable a user to better secure use of the user's account by allowing interaction with system 100 to select overdraft features in real-time when a need for the overdraft feature is determined to be needed. It may also better secure use of the user's account by enabling a user to the ability to select the overdraft feature remotely and with a degree of control to precisely define the scope of the overdraft feature.

In various embodiments, user application 104 may also display any of the information of data fields 110-128, such as the account number 110, whether the account is opted-in to use of activation feature selections 112, categories of authorized or unauthorized destination accounts 114, whether the account is opted in to receiving alerts 116, the amount of direct deposit enabled 118, the past overdraft record of the account 120, the past overdraft repayment record of the account 122, the balance of the account before the activation feature selection is made, the age of the account 126, and/or the amount of overdraft funds available 128. User application 104 may further be configured to display: a proposed transaction and any information associated with the transaction; options to change user account preferences such as how alerts are received or what information is displayed; or information about the entity backing the data system, such as contact information.

For system 100 to better secure use of the user's account, server application 106 may provide activation feature selection options to the user, which may be communicated to the user through user application 104. Such activation feature selection options may include specified time period-based, transaction-based, and point-of-sale based.

In various embodiments, activation feature selection type specified time period-based may be selected by the user in situations where the user anticipates an overdraft transaction or multiple overdraft transactions. Once selected, the user may specify, through user application 104, parameters for the specified time period-based activation feature selection, which may include a future date and time at which the period may begin, and the duration of the period or end. If the activation feature selection type specified time period-based is authorized, server application 106 may authorize all eligible attempted overdraft transactions during the time period specified.

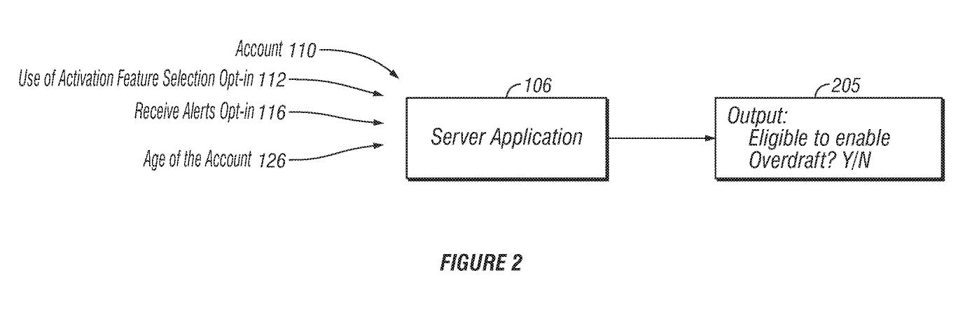

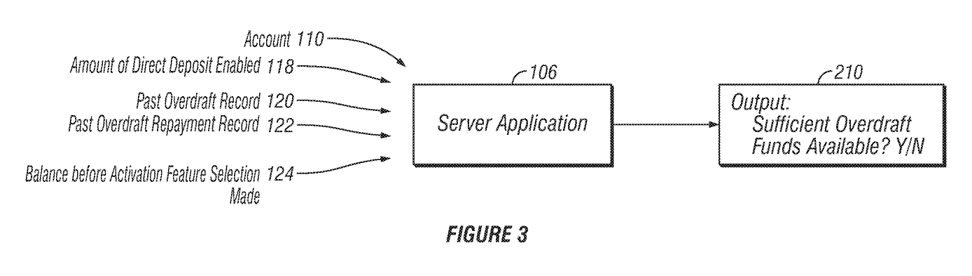

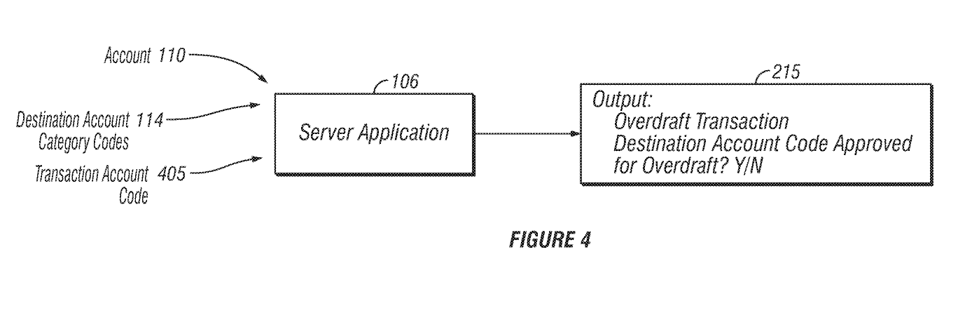

An overdraft transaction may be determined to be eligible by server application 106 by performing checks to generate certain outputs, such as output 205 (as contemplated in FIG. 2), output 210 (as contemplated in FIG. 3), and output 215 (as contemplated in FIG. 4). In various embodiments, output 205 may identify whether the account is eligible to enable an overdraft transaction, output 210 may identify whether the account has sufficient overdraft funds available to complete an overdraft transaction, and output 215 may identify whether the destination account associated with the attempted or proposed overdraft transaction is characterized by a code understood by system 100 to allow authorization of an overdraft transaction. Each output 205, 210, and 215 may be generated in any order and may be considered in any order independently or in combination with the other outputs, by server application 106 to finally determine whether an overdraft transaction may be authorized or declined.

In various embodiments, activation feature selection type transaction-based may be selected by the user in situations where the user anticipates an overdraft transaction or multiple overdraft transactions. Once selected, user application 104 may prompt the user to enter information about the overdraft transaction such as the type of destination account or an estimated amount of transaction. If the activation feature selection type transaction-based is authorized, server application 106 may authorize the next eligible overdraft transaction attempted following authorization of the activation feature selection.

In various embodiments, activation feature selection type point-of-sale-based may be selected by the user in situations where the user may not anticipate an overdraft transaction or multiple overdraft transactions. For example, in a situation where the user attempts a transaction, which is then declined for insufficient account funds, server application 106 may alert the user of the declined transaction and may provide the user with activation feature selection type point-of-sale-based, in addition to other activation feature selection types. Activation feature selection type point-of-sale-based may then be selected by the user before re-attempting the overdraft transaction. If the activation feature selection type point-of-sale-based is authorized, server application 106 may authorize the next eligible overdraft transaction at the point of sale.

The present invention is not to be limited to a point of sale as a single specific physical location. Rather, the point of sale may be a single chain or branch of stores with a single name (e.g., any X brand store), a chain or branch of stores in a particular geographic region (e.g., any X brand store in San Francisco), a chain or branch of stores that may include other stores within the same ownership structure (e.g., any X brand store or Y brand store because both X and Y are owned by the same company), or a single specific physical location (e.g., the X brand store at the exact physical address where the initial overdraft transaction was first declined). Processor 130 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 130 may interpret and/or execute program instructions and/or process data stored in memory 132. Memory 132 may be configured in part or whole as application memory, system memory, or both. Memory 132 may include any system, device, or apparatus configured to hold and/or house one or more memory modules. Each memory module may include any system, device or apparatus configured to retain program instructions and/or data for a period of time (e.g., computer-readable media). The various servers, electronic devices, or other machines described below may contain one or more similar such processors or memories for storing and executing program instructions for carrying out the functionality of the associated machine.

FIG. 2 illustrates an example embodiment of server application 106, showing the interaction of server application 106 and application database 103 to produce output 205. In one embodiment, output 205 may identify whether the user of system 100 is eligible to enable an overdraft transaction. In order to generate output 205, server application 106 may utilize any suitable information, such as those shown in account 110, system opt-in 112, whether the user has opted-in to receiving alerts 116, and age of the account 126.

In various embodiments, server application 106 may generate output 205 identifying that the user is eligible to enable an overdraft transaction if the following parameters are met: account 110 is a valid user account (e.g., not suspended or in breach of a system policy); account 110 is opted-in to use of system 100 for account security, which may be indicated by data field 112; account 110 is opted-in to receiving alerts from system 100 (e.g., for account activity), which may be indicated by data field 116; and account 110 has been in existence for a sufficient length of time (e.g., greater than a month), which may be indicated by data field 126.

In various embodiments, server application 106 may generate output 205 identifying that the user is not eligible to enable an overdraft transaction if the following parameters are met: account 110 is not a valid user account (e.g., suspended or in breach of a system policy); account 110 is not opted-in to use of system 100 for account security, which may be indicated by data field 112; account 110 is not opted-in to receiving alerts from system 100 (e.g., for account activity), which may be indicated by data field 116; or account 110 has not been in existence for a sufficient length of time (e.g., less than a month or other specified time period), which may be indicated by data field 126.

Output 205 may be considered by server application 106 to authorize or decline a user-selected activation feature selection before or after server application 106 generates or considers output 210 (as contemplated in FIG. 3) or output 215 (as contemplated in FIG. 4). In one embodiment, output 210 may identify whether account 110 has sufficient overdraft funds available to complete an overdraft transaction and output 215 may identify whether the destination account associated with the attempted or proposed overdraft transaction is characterized by a code understood by system 100 to allow authorization of an overdraft transaction. In various embodiments, server application 106 may decline a user-selected activation feature selection, based on output 205 identifying that account 110 is not eligible to enable an overdraft transaction, before server application 106 generates outputs 210 or 215, or before it considers outputs 210 or 215. Server application 106 may generate outputs 205, 210, and 215 in any order, wherein at least outputs 205, 210, and 215 may be considered by server application 106 to generate a final authorization or decline of an overdraft transaction.

FIG. 3 illustrates an example embodiment of server application 106, showing the interaction of server application 106 and application database 103 to produce output 210. In one embodiment, output 210 may identify whether the user of system 100 has sufficient overdraft funds available to complete an overdraft transaction. In order to generate output 210, server application 106 may utilize any suitable information, such as those shown in account 110, the amount of direct deposit enabled to be deposited into the account 118, the past overdraft transaction record of the account 120, the past overdraft repayment record of the account 122, and the balance of the account before the user selects an activation feature selection 124.

In various embodiments, server application 106 may generate output 210 identifying that the user is eligible to enable an overdraft transaction if the following parameters are met: account 110 is a valid user account (e.g., not suspended or in breach of a system policy); there is a sufficient direct deposit enabled to be deposited into the account 118 (e.g., greater than zero units per month); the past overdraft transaction record of the account does not exceed a specified threshold 120 (e.g., not greater than three overdraft transactions have been completed within the prior week); the past overdraft repayment record of the account 122 is within a specified range (e.g., the balance has been restored to a positive balance within a specified “grace period” after at least half of the account's overdraft transactions); and the balance of the account before the user selects an activation feature selection 124 is greater than a specified threshold (e.g., a positive balance).

In various embodiments, server application 106 may generate output 210 identifying that the user is not eligible to enable an overdraft transaction if the following parameters are met: account 110 is not a valid user account (e.g., not suspended or in breach of a system policy); there is an insufficient direct deposit enabled to be deposited into the account 118 (e.g., equal or less than zero units per month); the past overdraft transaction record of the account exceeds a specified threshold 120 (e.g., greater than three overdraft transactions have been completed within the prior week); the past overdraft repayment record of the account 122 is outside a specified range (e.g., the balance has not been restored to a positive balance within a specified “grace period” after at least half of the account's overdraft transactions); and the balance of the account before the user selects an activation feature selection 124 is less than a specified threshold (e.g., a negative balance).

Output 210 may be considered by server application 106 to authorize or decline a user-selected activation feature selection before or after server application 106 generates or considers output 205 (as contemplated in FIG. 2) output 215 (as contemplated in FIG. 4). In one embodiment, output 205 may identify whether account 110 is eligible to enable an overdraft transaction and output 215 may identify whether the destination account is characterized by a code understood by system 100 to allow authorization of an overdraft transaction. In various embodiments, server application 106 may decline a user-selected activation feature selection, based on output 210 identifying that account 110 does not have sufficient overdraft funds available to complete an overdraft transaction, before server application 106 generates outputs 205 or 215, or before it considers outputs 205 or 215.

FIG. 4 illustrates an example embodiment of server application 106, showing the interaction of server application 106 and application database 103 to produce output 215. In one embodiment, output 215 may identify whether the attempted or proposed overdraft transaction is acceptable given the value of destination account category code 114, signifying the type of destination account. In order to generate output 215, server application 106 may utilize any suitable information, such as those shown in account 110, destination account category codes 114, and transaction account code 405. Server application 106 may determine the destination account category codes 114 and compare these against a transaction account category code 405. Transaction account category code 405 may be obtained from an identification or characterization of the attempted or proposed destination account.

In one embodiment, destination account category codes 114 may represent categories of accounts, destinations, merchants, or entities for which an overdraft transaction is allowed. The specific codes allowed for a given account may vary from account to account. For example, if an account has had direct deposited enabled for greater than five years, the account may be allowed to perform an overdraft transaction with certain destination accounts that other accounts would typically be prohibited from performing an overdraft transaction with. In this example, the account that has had direct deposited enabled may be associated with certain destination account category codes 114 that differ from other accounts that have not met such requirements. In such an embodiment, server application 106 may compare the value of transaction account category code 405 with a list of values from destination account category codes 114. If the value of transaction account category code 405 is found within the values from destination account category codes 114, then server application 106 may generate output 215 indicating that the attempted or proposed transaction will be allowed at least with respect to destination account category codes 114. Server application 106 may also evaluate whether account 110 is a valid, active account (e.g., not suspended or in breach of a system policy), and if not, may generate output 215 indicating that the attempted or proposed transaction will not be allowed. In a further embodiment, if transaction account category code 405 is not within the values of destination account category codes 114, then server application 106 may generate output 215 indicating that the attempted or proposed transaction will not be allowed at least with respect to destination account category codes 114. As a result, the account is secured by allowing certain overdraft transactions to be performed if transaction account category code 405 conforms to a list of values of destination account category codes 114; if transaction account category code 405 does not conform, the attempted or proposed overdraft transaction may be declined by default.

In another embodiment, destination account category codes 114 may represent categories of accounts, destinations, merchants, or entities for which an overdraft transaction is not allowed. The specific codes allowed for a given account may vary from account to account. For example, if an account has not had direct deposited enabled for greater than five years, the account may not be allowed to perform an overdraft transaction with certain destination accounts that other accounts meeting that requirement may be allowed to perform an overdraft transaction with. In this example, the account that has not had direct deposited enabled may not be associated with certain destination account category codes 114 that differ from other accounts that have met such requirements. In such an embodiment, server application 106 may compare the value of transaction account category code 405 with a list of values from destination account category codes 114. If the value of transaction account category code 405 is found within the values from destination account category codes 114, then server application 106 may generate output 215 indicating that the attempted or proposed transaction will not be allowed at least with respect to destination account category codes 114. Server application 106 may also evaluate whether account 110 is a valid, active account (e.g., not suspended or in breach of a system policy), and if not, may generate output 215 indicating that the attempted or proposed transaction will not be allowed. In a further embodiment, if transaction account category code 405 is not within the values of destination account category codes 114, then server application 106 may generate output 215 indicating that the attempted or proposed transaction will be allowed at least with respect to destination account category codes 114. As a result, the account is secured by allowing certain overdraft transactions to be performed if transaction account category code 405 does not conform to a list of values of destination account category codes 114; if transaction account category code 405 does not conform, the attempted or proposed overdraft transaction may be authorized by default.

Output 215 may be considered by server application 106 to authorize or decline a user-selected activation feature selection before or after server application 106 generates or considers output 205 (as contemplated in FIG. 2) or output 210 (as contemplated in FIG. 3). In one embodiment, output 205 may identify whether account 110 has sufficient overdraft funds available to complete an overdraft transaction and output 210 may identify whether account 110 has sufficient overdraft funds available to complete an overdraft transaction

In various embodiments, server application 106 may decline a user-selected activation feature selection, based on output 215 identifying that the destination account associated with the attempted or proposed overdraft transaction is not characterized by a code understood by system 100 to allow authorization of an overdraft transaction, before server application 106 generates outputs 205 or 210, or before it considers outputs 205 or 210.

FIG. 5 illustrates example operation of an embodiment of server application 106 interacting with a system 100 user application 104 and point of sale 505.

In one embodiment, FIG. 5 illustrates the performance of an activation feature selection type specified time period-based. As discussed in FIG. 1, activation feature selection type specified time period-based may be selected by the user in situations where the user anticipates an overdraft transaction or multiple overdraft transactions. If the activation feature selection type specified time period-based is authorized, server application 106 may authorize all eligible attempted overdraft transactions during the time period specified. In one embodiment, system 100 may perform an activation feature selection type that is specified as time period-based.

At (1), server application 106 may receive the activation feature selection type specified as time period-based from user application 104. Once selected, the user may specify, through user application 104, parameters for the specified time period-based activation feature selection, which may include a future date and time at which the period may begin, and the duration of the period or end (e.g., 48 hours from the time the activation feature selection is authorized; 48 hours beginning at a time specified two days after the time the activation feature selection is authorized; a default amount of time from the time the activation feature selection is authorize; or a default amount of time beginning at a date and time specified in the future).

At (2), server application 106 may first check output 205 to determine whether user account 150, attributed to user application 104, is eligible to enable an overdraft transaction.

To perform check 205, server application 106 may retrieve information from application database 103, as described in FIG. 2. In various embodiments, output 205 may identify whether the account is eligible to enable an overdraft transaction. If output 205 identifies that the account is eligible to enable an overdraft transaction, server application 106 may continue to (3); if output 205 identifies that the account is not eligible, server application 106 may decline the activation feature selection.

At (3), server application 106 may send a notification to the user's user application 104 indicating that the user-selected activation feature selection of type specified time period-based is authorized.

At (4), when the user attempts an overdraft transaction at point of sale 505, server application 106 may perform, at (5), checks 210 and 215. To perform check 210, server application 106 may retrieve information from application database 103, as described in FIG. 3, to provide server application 106 with the output of whether account 150 has sufficient overdraft funds available to complete the attempted transaction. To perform check 215, server application 106 may retrieve information from application database 103, as described in FIG. 4, to provide server application 106 with the output of whether the destination account associated with the attempted or proposed overdraft transaction is characterized by a code understood by system 100 to allow authorization of an overdraft transaction. Server application 106 may decline the activation feature selection if output 210 identifies that sufficient overdraft funds are not available to complete the attempted transaction, or if output 215 identifies that the destination account associated with the attempted or proposed overdraft transaction is not characterized by a code understood by system 100 to allow authorization of an overdraft transaction.

At (6), server application 106 may authorize the attempted overdraft transaction if the following parameters are met: output 205 identifies that user account 150 is eligible to enable an overdraft transaction, output 210 identifies that sufficient overdraft funds are available to complete the attempted overdraft transaction, and output 215 identifies that the destination account associated with the attempted or proposed overdraft transaction is characterized by a code understood by system 100 to allow authorization of an overdraft transaction, and the attempted overdraft transaction is within the period of time specified by the user at the time server application 106 first received the activation feature selection. Any one, all, or any combination of the checks performed by generating or retrieving outputs 205, 210, and 215 may be used to decline the attempted overdraft transaction.

In another embodiment, FIG. 5 illustrates the performance of an activation feature selection type transaction-based. As discussed in FIG. 1, activation feature selection type transaction-based may be selected by the user in situations where the user anticipates an overdraft transaction or multiple overdraft transactions. If the activation feature selection type transaction-based is authorized, server application 106 may authorize the next eligible overdraft transaction attempted following authorization of the activation feature selection.

At (1), server application 106 receives the activation feature selection type transaction-based from user application 104. Once selected, user application 104 may prompt the user to enter information about the overdraft transaction such as the type of destination account or an estimated amount of transaction. If the activation feature selection type transaction-based is authorized, server application 106 may authorize the next eligible overdraft transaction attempted following authorization of the activation feature selection.

At (2), server application 106 may first check output 205 to determine whether user account 150, attributed to user application 104, is eligible to enable an overdraft transaction. To perform check 205, server application 106 may retrieve information from application database 103, as described in FIG. 2. In various embodiments, output 205 may identify whether the account is eligible to enable an overdraft transaction. If output 205 identifies that the account is eligible to enable an overdraft transaction, server application 106 may continue to (3); if output 205 identifies that the account is not eligible, server application 106 may decline the activation feature selection.

At (3), server application 106 may send a notification to the user application 104 indicating that the user-selected activation feature selection of type transaction-based is authorized.

At (4), when the user attempts a next overdraft transaction at point of sale 505, server application 106 may perform, at (5), checks 210 and 215. To perform check 210, server application 106 may retrieve information from application database 103, as described in FIG. 3, to provide server application 106 with the output of whether account 150 has sufficient overdraft funds available to complete the attempted transaction. To perform check 215, server application 106 may retrieve information from application database 103, as described in FIG. 4, to provide server application 106 with the output of whether the destination account associated with the attempted or proposed overdraft transaction is characterized by a code understood by system 100 to allow authorization of an overdraft transaction. Server application 106 may decline the activation feature selection if output 210 identifies that sufficient overdraft funds are not available to complete the attempted transaction, or if output 215 identifies that the destination account associated with the attempted or proposed overdraft transaction is not characterized by a code understood by system 100 to allow authorization of an overdraft transaction.

At (6), server application 106 may authorize the attempted overdraft transaction if the following parameters are met: output 205 identifies that user account 150 is eligible to enable an overdraft transaction, output 210 identifies that sufficient overdraft funds are available to complete the attempted overdraft transaction, and output 215 identifies that the destination account associated with the attempted or proposed overdraft transaction is characterized by a code understood by system 100 to allow authorization of an overdraft transaction, and the attempted overdraft transaction is the next overdraft transaction attempted immediately after the activation feature selection type transaction-based is authorized. Any one, all, or any combination of the checks performed by retrieving outputs 205, 210, and 215 may be used to decline the attempted overdraft transaction.

FIG. 6 illustrates example operation of an embodiment of the server application 106 interacting with a system 100 user application 104 and point of sale 505. In one embodiment, system 100 may perform an activation feature selection type that is specified as point-of-sale-based. In various embodiments, activation feature selection type point-of-sale-based may be selected by the user in situations where the user may not anticipate an overdraft transaction or multiple overdraft transactions. For example, in a situation where the user attempts a transaction, which is then declined for insufficient account funds, server application 106 may alert the user of the declined transaction and may provide the user with activation feature selection type point-of-sale-based, in addition to other activation feature selection types. Activation feature selection type point-of-sale-based may then be selected by the user before re-attempting the overdraft transaction. If the activation feature selection type point-of-sale-based is authorized, server application 106 may authorize the next eligible overdraft transaction at the point of sale.

At (1), server application 106 may receive notification that a user has attempted a transaction at point of sale 605. Once selected, the user may specify, through user application 104, parameters for the specified time period-based activation feature selection, which may include a future date and time at which the period may begin, and the duration of the period or end (e.g., 48 hours from the time the activation feature selection is authorized; 48 hours beginning at a time specified two days after the time the activation feature selection is authorized; a default amount of time from the time the activation feature selection is authorize; or a default amount of time beginning at a date and time specified in the future).

At (2), server application 106 may decline the attempted transaction for insufficient account funds. At (3), server application 106 may notify the user, on user's User application 104, that the transaction has been denied and may notify the user of available activation feature selection options. Such activation feature selection options may include transaction-based and specified time period-based, each as described in FIG. 5, or point-of-sale based. At (4), server application 106 may receive activation feature selection type point-of-sale based from User application 104.

At (5), server application 106 may perform checks 205 and 215 in any order. To perform check 205, server application 106 may retrieve information from application database 103, as described in FIG. 2. In various embodiments, output 205 may identify whether the account is eligible to enable an overdraft transaction. If output 205 identifies that the account is eligible to enable an overdraft transaction, server application 106 may continue to (3); if output 205 identifies that the account is not eligible, server application 106 may decline the activation feature selection. To perform check 215, server application 106 may retrieve information from application database 103, as described in FIG. 4, to provide server application 106 with the output of whether the destination account associated with the attempted or proposed overdraft transaction is characterized by a code understood by system 100 to allow authorization of an overdraft transaction. Server application 106 may decline the activation feature selection if output 205 identifies that user account 150 is not eligible to enable an overdraft transaction, or if output 215 identifies that the destination account associated with the attempted or proposed overdraft transaction is characterized by a code understood by system 100 to allow authorization of an overdraft transaction.

At (6), after server application 106 has completed checks 205 and 215, and has confirmed that user account 150 is eligible to enable an overdraft transaction and that the merchant category code of the point of sale is in the category to be authorized, server application 106 may send a notification to User application 104 indicating that activation feature selection type point-of-sale based is authorized.

At (7), server application 106 may receive notification that the user has re-attempted a transaction at point of sale 605.

At (8), server application 106 may perform check 210 to determine whether account 150 has sufficient overdraft funds available to complete the overdraft transaction. To perform check 210, server application 106 may retrieve information from application database 103, as described in FIG. 3, to provide server application 106 with the output of whether account 150 has sufficient overdraft funds available to complete the attempted transaction. Server application 106 may decline the overdraft transaction if output 210 identifies that sufficient overdraft funds are not available to complete the attempted overdraft transaction.

At (9), server application 106 may authorize attempted overdraft transaction if the following parameters are met: output 205 identifies that user account 150 is eligible to enable an overdraft transaction, output 210 identifies that sufficient overdraft funds are available to complete the attempted overdraft transaction, and output 215 identifies that the destination account associated with the attempted or proposed overdraft transaction is characterized by a code understood by system 100 to allow authorization of an overdraft transaction, and the attempted overdraft transaction is within the period of time specified by the user at the time server application 106 first received the activation feature selection.

The present invention is not limited to a point of sale 605 as a single specific physical location. Rather, the point of sale may be a single chain or branch of stores with a single name (e.g., any X brand store), a chain or branch of stores in a particular geographic region (e.g., any X brand store in San Francisco), a chain or branch of stores that may include other stores within the same ownership structure (e.g., any X brand store or Y brand store because both X and Y are owned by the same company), or a single specific physical location (e.g., the X brand store at the exact physical address where the initial overdraft transaction was first declined).

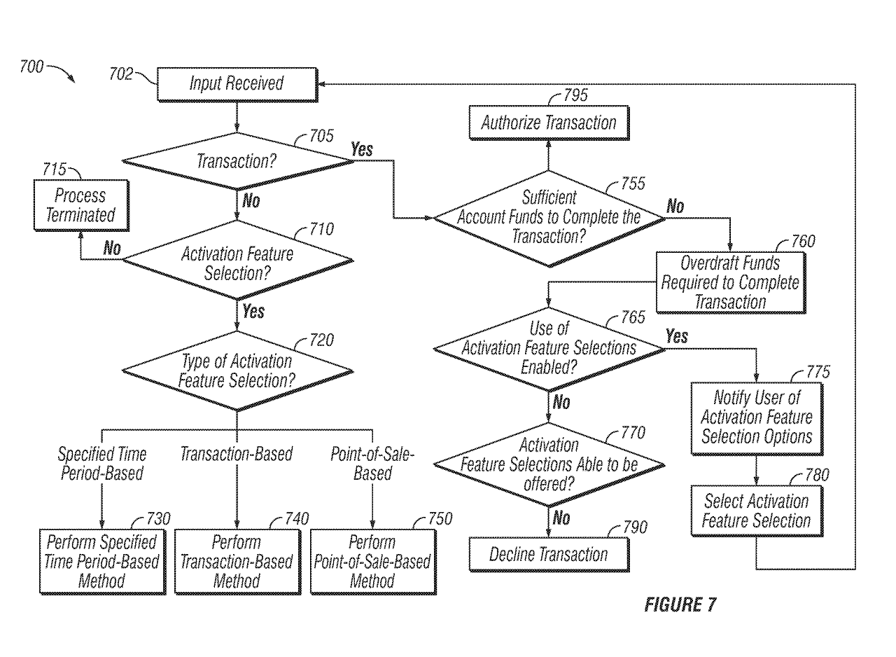

FIG. 7 depicts a method 700 for securing accounts and features within such accounts, in accordance with embodiments of the present disclosure. At step 702, an input may be received by a processor with a memory, wherein the input may indicate an activation feature selection or a transaction.

At step 705, the input may be evaluated to determine if it is a transaction. If the input received is a transaction, whether sufficient account funds are available to complete the transaction may be determined at step 755, and if sufficient account funds are available, the transaction may be authorized at 795. If sufficient account funds are not available to complete the transaction, overdraft funds may be required to complete the transaction and whether use of activation feature selections has been enabled may be determined at step 765. If use of activation feature selections has been enabled, at step 775, the user may be notified of available activation feature selection options. Notification may be performed in any suitable way. For example, a server making the determinations of method 700 may inform a communication network, which may be in communication with a device owned by a user or by a point-of-sale device accessible by the user. In another example, 775 may be performed by such a communication device of the user or by a point-of-sale device accessible by the user. At step 780, the user may select an activation feature selection. If use of activation feature selections has not been enabled, at step 770, whether activation feature selections are able to be offered may be determined. If activation feature selections are not able to be offered, the transaction may be denied at 790. If activation feature selections are able to be offered, at step 775, the user may be notified of available activation feature selection options. At step 780, the user may select an activation feature selection.

At step 705, if the input evaluated is determined not to be a transaction, whether the input is an activation feature selection may be determined at 710. If the input is not an activation feature selection, at 715, the process terminates and a security alert may be sent to the user. The security alert may indicate that an unknown or potentially unauthorized input has been received. If the input is an activation feature selection, at 720, the type of activation feature selection may be determined.

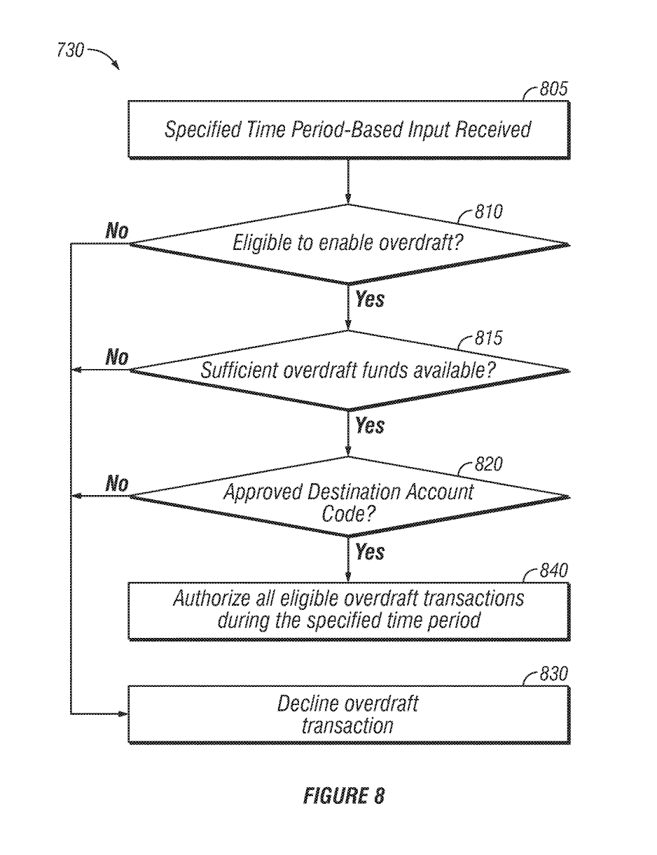

At step 720, if the activation feature selection is determined to be specified time period-based, the method for the specified time period-based activation feature selection may be performed at 730. Steps of method 730 may be performed as described in FIG. 8, wherein the steps may include determining whether an account is eligible to enable an overdraft transaction, determining whether sufficient overdraft funds are available to complete the transaction, and determining whether the destination account is characterized by a code to allow authorization of an overdraft transaction. Based on any one or all of these determinations, the activation feature selection may be authorized or declined. If the activation feature selection is authorized, all eligible overdraft transactions during the specified time period may be authorized.

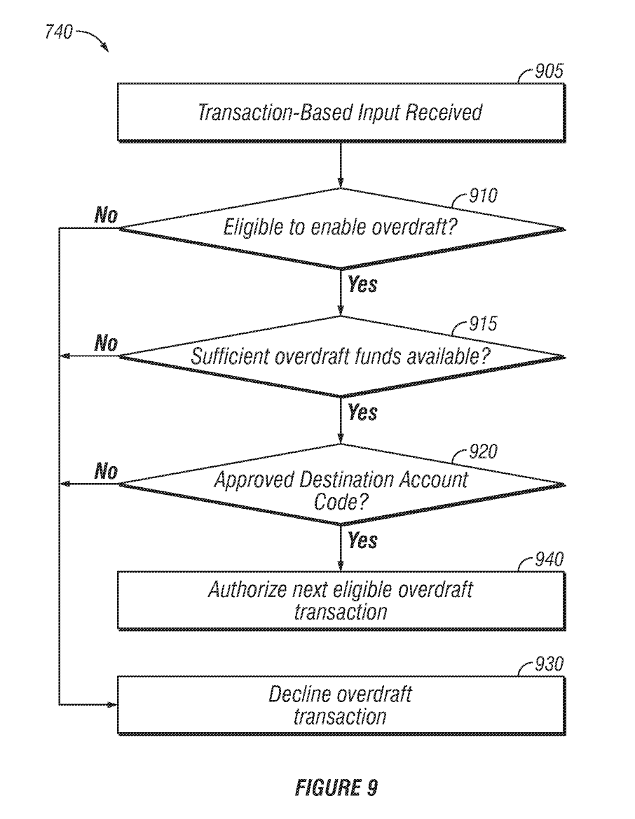

At step 720, if the activation feature selection is determined to be transaction-based, the method for the transaction-based activation feature selection may be performed at 740. Steps of method 740 may be performed as described in FIG. 9, wherein the steps may include determining whether an account is eligible to enable an overdraft transaction, determining whether sufficient overdraft funds are available to complete the transaction, and determining whether the destination account is characterized by a code to allow authorization of an overdraft transaction. Based on any one or all of these determinations, the overdraft transaction may be authorized or declined. If the activation feature selection is authorized, the next eligible overdraft transaction may be authorized.

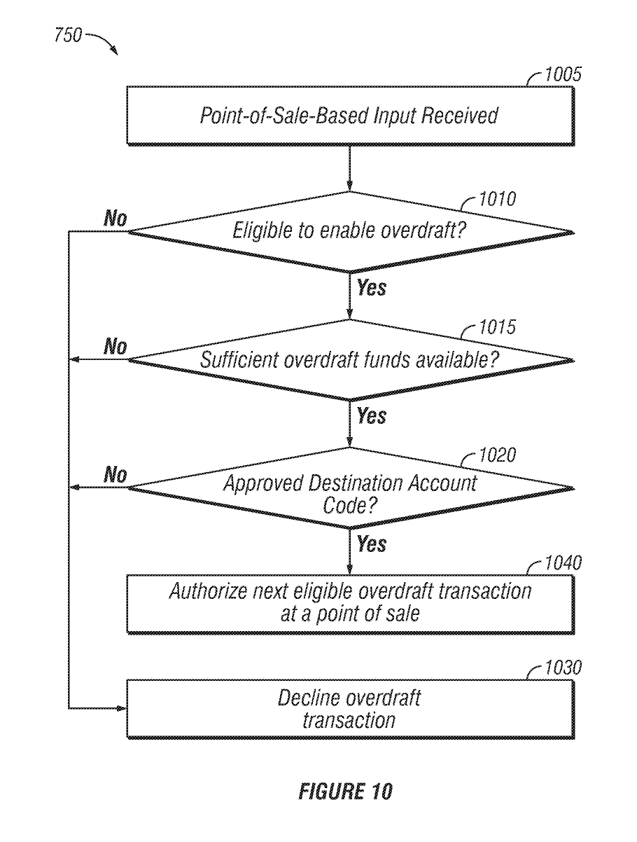

At step 720, if the activation feature selection is determined to be point-of-sale-based, the method for the point-of-sale-based activation feature selection may be performed at 750. Steps of method 750 may be performed as described in FIG. 10, wherein the steps may include determining whether an account is eligible to enable an overdraft transaction, determining whether sufficient overdraft funds are available to complete the transaction, and determining whether the destination account is characterized by a code to allow authorization of an overdraft transaction. Based on any one or all of these determinations, the overdraft transaction may be authorized or declined. If the activation feature selection is authorized, the next eligible overdraft transaction at a point of sale may be authorized.

FIG. 8 depicts a method 730 for securing accounts and features within such accounts based on an activation feature selection specified time period-based, in accordance with embodiments of the present disclosure. At 805, a specified time period-based input may be received by a processor with a memory. At step 810, whether an account is eligible to enable an overdraft transaction may be determined, and if the account is not eligible to enable an overdraft transaction, the activation feature selection may be denied at 830. If the account is eligible to enable an overdraft transaction, at step 815, whether the account has sufficient overdraft funds to complete the overdraft transaction may be determined. If the account does not have sufficient overdraft funds to complete the overdraft transaction, the activation feature selection may be denied at 830. If the account has sufficient overdraft funds to complete the overdraft transaction, at step 820, whether the destination account is characterized by a code which allows for authorization of an overdraft transaction may be determined. If the destination account is not characterized by a code to allow authorization of an overdraft transaction, the activation feature selection may be denied at 830. If the destination account is characterized by a code to allow authorization of an overdraft transaction, at 840, the activation feature selection may be authorized. If the activation feature selection is authorized, all eligible overdraft transactions during the specified time period may be authorized. The authorization may be performed, for example, on a server by changing a setting allowing the account to be overdrafted or, in another example, on a mobile device or point-of-sale device accessible by the user when such a setting is changed.

FIG. 9 depicts a method 740 for securing accounts and features within such accounts based on an activation feature selection transaction-based, in accordance with embodiments of the present disclosure. At 905, a transaction-based input may be received by a processor with a memory. At step 910, whether an account is eligible to enable an overdraft transaction may be determined, and if the account is not eligible to enable an overdraft transaction, the activation feature selection may be denied at 930. If the account is eligible to enable an overdraft transaction, at step 915, whether the account has sufficient overdraft funds to complete the overdraft transaction may be determined. If the account does not have sufficient overdraft funds to complete the overdraft transaction, the activation feature selection may be denied at 930. If the account has sufficient overdraft funds to complete the overdraft transaction, at step 920, whether the destination account is characterized by a code to allow authorization of an overdraft transaction may be determined. If the destination account is not characterized by a code which allows for authorization of an overdraft transaction, the activation feature selection may be denied at 930. If the destination account is characterized by a code to allow authorization of an overdraft transaction, at 940, the activation feature selection may be authorized. At step 940, if the activation feature selection is authorized, the next eligible overdraft transaction may be authorized. The authorization may be performed, for example, on a server by changing a setting allowing the account to be overdrafted or, in another example, on a mobile device or point-of-sale device accessible by the user when such a setting is changed.

FIG. 10 depicts a method 750 for securing accounts and features within such accounts based on an activation feature selection point-of-sale-based, in accordance with embodiments of the present disclosure. At 1005, a point-of-sale-based input may be received by a processor with a memory. At step 1010, whether an account is eligible to enable an overdraft transaction may be determined, and if the account is not eligible to enable an overdraft transaction, the activation feature selection may be denied at 1030. If the account is eligible to enable an overdraft transaction, at step 1015, whether the account has sufficient overdraft funds to complete the overdraft transaction may be determined. If the account does not have sufficient overdraft funds to complete the overdraft transaction, the activation feature selection may be denied at 1030. If the account has sufficient overdraft funds to complete the overdraft transaction, at step 1020, whether the destination account is characterized by a code which allows for authorization of an overdraft transaction may be determined. If the destination account is not characterized by a code to allow authorization of an overdraft transaction, the activation feature selection may be denied at 1030. If the destination account is characterized by a code to allow authorization of an overdraft transaction, at 1040, the activation feature selection may be authorized. At step 1040, if the activation feature selection is authorized, the next eligible overdraft transaction at a point of sale may be authorized. The authorization may be performed, for example, on a server by changing a setting allowing the account to be overdrafted or, in another example, on a mobile device or point-of-sale device accessible by the user when such a setting is changed.

Methods 700, 800, 900, and 1000 may be implemented using the system of FIGS. 1-6, or any other suitable system. The preferred initialization point for such methods and the order of their steps may depend on the implementation chosen. In some embodiments, some steps may be optionally omitted, repeated, or combined. In some embodiments, some steps of such methods may be executed in parallel with other steps. In certain embodiments, the methods may be implemented partially or fully in software embodied in computer-readable media. Some portions of methods 700, 800, 900, and 1000 may be implemented by servers or other computing systems protecting access to accounts. Still other portions of methods 700, 800, 900, and 1000 may be implemented by point-of-sale devices, systems, or other clients.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A method, comprising:
receiving, from a user, an activation feature selection;
evaluating a type of the activation feature selection, the type to include one or more of a specified time period-based, a transaction-based, or a point-of-sale-based;
determining whether the user is eligible to enable at least one overdraft transaction; and
based on receiving the activation feature selection and on a determination that the user is eligible to enable an overdraft transaction, activating an overdraft feature based on the type of the activation feature selection.

2. The method of claim 1, wherein activating the overdraft feature includes activating the overdraft feature for a specific time period based upon a determination that the activation feature selection type is specified time period-based.

3. The method of claim 2, further comprising authorizing all eligible overdraft transactions during the specified time period.

4. The method of claim 1, wherein activating the overdraft feature includes activating the overdraft feature for a next eligible overdraft transaction based upon a determination that the activation feature selection type is transaction-based.

5. The method of claim 4, further comprising authorizing the next eligible overdraft transaction immediately following activation of the overdraft feature.

6. The method of claim 1, wherein activating the overdraft feature includes activating the overdraft feature at the point-of-sale based upon a determination that the activation feature selection type is point-of-sale-based, after receiving an attempted overdraft transaction and declining the attempted overdraft transaction based upon an insufficiency in account funds.

7. The method of claim 6, further comprising authorizing at least the next eligible overdraft transaction at the point-of-sale.

8. The method of claim 1, wherein determining whether the user is eligible to enable at least one overdraft transaction includes consideration of a type of account, age of the account, an overdraft program opt-in, and a consent to receiving account alerts opt-in.

9. The method of claim 1, further comprising:
determining whether sufficient overdraft funds are available to complete the overdraft transaction, wherein determining whether sufficient overdraft funds are available includes a type of account, age of the account, an amount of direct deposit enabled to the account, past overdraft record of the account, past repayment record of the account, and an account balance before the activation feature selection is made; and
based on an aggregation of the considerations, decline activation of the overdraft feature selection.

10. The method of claim 1, further comprising:
receiving an attempted overdraft transaction;
determining a point-of-sale that generated the attempted overdraft transaction;
declining the attempted overdraft transaction based upon a destination account categorization of the point-of-sale that generated the attempted overdraft transaction.

11. A system, comprising:
a processor;
a non-transitory computer-readable medium;
instructions on the non-transitory computer-readable medium, the instructions, when read and executed by the processor, configure the processor to:
receive, from a user, an activation feature selection;
evaluate a type of the activation feature selection, the type to include one or more of a specified time period-based, a transaction-based, or a point-of-sale-based;
determine whether the user is eligible to enable at least one overdraft transaction; and
based on receiving an activation feature selection and on a determination that the user is eligible to enable an overdraft transaction, activate an overdraft feature based on the type of the activation feature selection.

12. The system of claim 11, wherein activating the overdraft feature includes activating the overdraft feature for a specific time period, based upon a determination that the activation feature selection type is a specified time period-based.

13. The system of claim 12, wherein the instructions are further configured to cause the processor to authorize all eligible overdraft transactions during the specified time period.

14. The system of claim 11, wherein activating the overdraft feature includes activating the overdraft feature for the next transaction, based upon a determination that the activation feature selection type is transaction-based.

15. The system of claim 14, wherein the instructions are further configured to cause the processor to authorize the next eligible overdraft transaction immediately following activation of the transaction-based activation feature selection.

16. The system of claim 11, wherein activating the overdraft feature includes activating the overdraft feature at the point-of-sale based upon a determination that the activation feature selection type is point-of-sale-based, after receiving an attempted overdraft transaction and declining the attempted overdraft transaction based upon an insufficiency in account funds.

17. The system of claim 16, wherein the instructions are further configured to cause the processor to authorize the next eligible overdraft transaction at the point-of-sale.

18. The system of claim 11, wherein determining whether the user is eligible to enable at least one overdraft transaction includes consideration of a type of account, age of the account, an overdraft program opt-in, and a consent to receiving account alerts opt-in.

19. The system of claim 11, further comprising instructions that are configured to cause the processor to:
determine whether sufficient overdraft funds are available to complete the overdraft transaction, wherein determining whether sufficient overdraft funds are available includes considerations of a type of account, age of the account, an amount of direct deposit enabled to the account, past overdraft record of the account, past repayment record of the account, and an account balance before the activation feature selection is made; and
based on an aggregation of the considerations, decline activation of the overdraft feature selection.

20. The system of claim 11, further comprising instructions that are configured to cause the processor to:
receive an attempted overdraft transaction;
determine a point-of-sale that generated the attempted overdraft transaction; and
decline the attempted overdraft transaction based upon a destination account categorization of the point-of-sale that generated the attempted overdraft transaction.

21. A computer program embodied in computer readable media comprising instructions, the instructions executable by a processor, the instructions configured to, when loaded and executed, cause the processor to:
receive, from a user, an activation feature selection;
evaluate a type of the activation feature selection, the type to include one or more of a specified time period-based, a transaction-based, or a point-of-sale-based;
determine whether the user is eligible to enable at least one overdraft transaction; and based on receiving an activation feature selection and on a determination that the user is eligible to enable an overdraft transaction, activate an overdraft feature based on the type of the activation feature selection.

22. The computer program of claim 21, wherein activating the overdraft feature includes activating the overdraft feature for a specific time period, based upon a determination that the activation feature selection type is a specified time period-based.

23. The computer program of claim 22, wherein the instructions are further configured to cause the processor to authorize all eligible overdraft transactions during the specified time period.

24. The computer program of claim 21, wherein activating the overdraft feature includes activating the overdraft feature for the next transaction, based upon a determination that the activation feature selection type is transaction-based.

25. The computer program of claim 24, wherein the instructions are further configured to cause the processor to authorize the next eligible overdraft transaction immediately following activation of the transaction-based activation feature selection.

26. The computer program of claim 21, wherein activating the overdraft feature includes activating the overdraft feature at the point-of-sale based upon a determination that the activation feature selection type is point-of-sale-based, after receiving an attempted overdraft transaction and declining the attempted overdraft transaction based upon an insufficiency in account funds.

27. The computer program of claim 26, wherein the instructions are further configured to cause the processor to authorize the next eligible overdraft transaction at the point-of-sale.

28. The computer program of claim 21, wherein determining whether the user is eligible to enable at least one overdraft transaction includes consideration of a type of account, age of the account, an overdraft program opt-in, and a consent to receiving account alerts opt-in.

29. The computer program of claim 21, further comprising instructions that are configured to cause the processor to:
determine whether sufficient overdraft funds are available to complete the overdraft transaction, wherein determining whether sufficient overdraft funds are available includes considerations of a type of account, age of the account, an amount of direct deposit enabled to the account, past overdraft record of the account, past repayment record of the account, and an account balance before the activation feature selection is made; and
based on an aggregation of the considerations, decline activation of the overdraft feature selection.

30. The computer program of claim 21, further comprising instructions configured to cause the processor to:
receive an attempted overdraft transaction;
determine a point-of-sale that generated the attempted overdraft transaction; and
decline the attempted overdraft transaction based upon a destination account categorization of the point-of-sale that generated the attempted overdraft transaction.
